(19) United States
(12) Patent Application Publication
(10) Pub. No.: US 2006/0069186 A1
(43) Pub. Date: Mar. 30, 2006

(54) Teeth whitening and cleaning composition

(76) Inventor: Irwin E. Smigel, New York, NY (US)

Correspondence Address: JENNIFER MEREDITH;MEREDITH & KEYHANI, PLLC, 330 MADISON AVE., 6TH FLOOR, NEW YORK, NY, 10017, US

(21) Appl. No.: 11/232,815

(22) Filed: Sep. 22, 2005

Related U.S. Application Data
(60) Provisional application No. 60/614,115, filed on Sep. 29, 2004.

(51) Int. Cl. C04B 24/22

(52) U.S. Cl. 524/247

(57) ABSTRACT

An oral care composition comprising: 24-33 percent by weight glycerine; 7-16 percent by weight calcium peroxide; 1-9 percent by weight triethanolamine; 1-5 percent by weight EDTA acid; 1-5 percent by weight dequest 2010; 0.25-2.5 percent by weight sodium saccharinate; 7-16 percent by weight citric acid; and 0.25-3.5 percent by weight carbopol 934.

### BACKGROUND OF THE INVENTION

This application claims priority to provisional patent application No. 60/614,115 as filed Sep. 29, 2004. The present invention relates generally to a composition for whitening human teeth, specifically to an improved composition that performs the dual functions of both whitening teeth and freshening breath by removing proteinaceous matter from the teeth.

It has become aesthetically desirable for persons to maintain white teeth. Dull-looking, stained teeth are objectionable to most people both on the basis of cosmetic appearance and also socially as an indication of poor oral hygiene. One whose teeth are white may enjoy more personal confidence and satisfaction and may even enjoy greater social acceptance.

A tooth is comprised of an inner dentin layer and an outer hard enamel layer, which is coated with a protective layer called the pellicle. Teeth can become stained when the staining materials penetrate the enamel or get trapped within the pellicle. Over time these trapped particles build up and begin to discolor teeth. This type of intrinsic staining is not amenable to mechanical methods of tooth cleaning, and chemical methods which can penetrate into the tooth structure are required.

Among the strategies available for removing tooth stains outside of a dental office, the most effective bleaching compositions contain a peroxy generating agent delivered in gel, paste or liquid form. These compositions act by oxidation. Common application methods include a tray that is custom molded to the person's tooth structure and holds a bleaching liquid which is fitted to the person's teeth, and a bleaching paste that is applied directly to the teeth and has the consistency to remain in place. For either application method, the bleaching compound is kept in contact with the teeth for a variable amount of time, ranging from approximately 7 minutes to 12 hours. This process is repeated daily for 1 to 2 weeks, depending upon the severity of the tooth staining.

Prior art discloses tooth bleaching compositions comprising various chemical make-ups. Although various tooth bleaching components exist, the most commonly used in prior art are hydrogen peroxide and urea peroxide.

U.S. Pat. No. 6,746,679 to Nathoo (Jun. 8, 2004) discloses a tooth whitening hydrogel that does not contain hydrocarbon humectants. A hydrocarbon humectant is defined as a carbon, hydrogen and oxygen compound which is used to prevent the oral care composition from hardening upon exposure to air or a carbon, hydrogen and oxygen compound which is used as a carrier for ingredients of an oral care composition. The hydrogel is claimed to contain either hydrogen or carbamide peroxide in combination with a mixed surfactant system.

U.S. Pat. No. 6,770,266 to Santarpia, III, et al. (Aug. 3, 2004) discloses an aqueous tooth whitening liquid composition comprised of an aqueous vehicle containing a film forming combination of an ethylene oxide linear homopolymer, a carbomer and a peroxide whitening agent, the pH of the composition being maintained at an acidic level. The invention claims either hydrogen peroxide or urea peroxide.

U.S. patent application No. 2002/0136929 of Zaidel et al. (Jul. 15, 2004) discloses a peroxide containing tooth whitening dentifrice. The composition is comprised of a separately maintained first component containing a peroxide compound and an abrasive system, and a second component containing a desensitizing compound and an abrasive that is incompatible with the peroxide compound. The two components are mixed and combined just before being applied to the teeth. The application claims either hydrogen peroxide or urea peroxide.

U.S. patent application No. 2003/0089886 of Montgomery (May 15, 2003) discloses a tooth bleaching composition that contains hydrogen peroxide, as well as a thickening agent, a stabilizer, a pH adjuster, and a calcium chelating agent. The application claims the use of hydrogen peroxide.

The present invention provides a gel for use to whiten and clean teeth, it does not require mixing and is easy to use and results in improved whitening and cleaning.

### SUMMARY OF THE INVENTION

The present invention embodies a dental whitening composition that also removes proteinacious matter from teeth without deleterious effect to tooth enamel or the mucus membrane of the mouth. The composition generally contains a peroxy tooth bleaching component, a breath freshening component and an aqueous delivery matrix.

A preferred embodiment comprises calcium peroxide as the bleaching component, a flavor composition as the breath freshening component and an aqueous delivery matrix. The aqueous delivery matrix may be comprised of deionized water, glycerine, triethanolamine, EDTA acid, Dequest 2010, sodium saccharinate, citric acid and carbopol 934.

According to another embodiment, an oral composition is disclosed having 24-33 percent by weight glycerine, 7-16 percent by weight calcium peroxide, 1-9 percent by weight triethanolamine, 1-5 percent by weight EDTA acid, 1-5 percent by weight dequest 2010; 0.25-2.5 percent by weight sodium saccharinate; 7-16 percent by weight citric acid; 0.25-3.5 percent by weight carbopol 934; and 0.25 to 2.5 percent by weight a flavor composition.

These and other features, aspects and advantages of the present invention will become better understood with reference to the description and claims.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

An oral care composition comprising a tooth bleaching component, a breath freshening component and an aqueous delivery matrix. The tooth bleaching compound may be comprised of calcium peroxide and the breath freshening component may be a flavor composition. According to a preferred embodiment the flavor composition is supersmile™. Supersmile™ is a flavor composition made up of between 40 percent and 60 percent mint and between 40 percent and 60 percent spearmint, prefereably 50 percent mint and 50 percent spearmint. The aqueous delivery matrix may be comprised of: deionized water, glycerine, triethanolamine, EDTA acid, Dequest 2010, sodium saccharinate, citric acid and carbopol 934. There may also be KoH and cellulose gum. The calcium peroxide is between 6% and 17% by weight, the flavor composition may be between 0.5% and 3% by weight, the deionized water may be between 13% and 53% by weight, the glycerine may be between 25% and 30% by weight, the triethenolamine may be between 2% and 8% by weight, the EDTA acid may be between 1% and 4% by weight, the Dequest 2010 may be between 1% and 4% by weight, the sodium saccherinate may be between 0.5% and 2% by weight, the citric acid may be between 8% and 15% by weight, the carbopol 934 may be between 0.5% and 3% by weight, and the KOH may be between 0.5% and 2% by weight. There may also be between 0.5% and 2% by weight cellulose gum.

An oral care composition comprising: 24-33 percent by weight glycerine; 7-16 percent by weight calcium peroxide; 1-9 percent by weight triethanolamine; 1-5 percent by weight EDTA acid; 1-5 percent by weight dequest 2010; 0.25-2.5 percent by weight sodium saccharinate; 7-16 percent by weight citric acid; and 0.25-3.5 percent by weight carbopol 934. There may also be between 0.25 to 2.5 percent by weight of a flavor composition, such as supersmile™. There may also be KOH being 0.25 to 2.5 percent by weight and cellulose gum being 0.25 to 2 percent by weight.

An oral care composition comprising 30 percent by weight glycerine; 15 percent by weight calcium peroxide; 8 percent by weight triethanolamine; 4 percent by weight EDTA acid; 4 percent by weight dequest 2010; 2.0 percent by weight sodium saccharinate; 15 percent by weight citric acid; and 3.0 percent by weight carbopol 934. There may also be between 2.0 percent by weight of a flavor composition, such as supersmile™. There may also be KOH being 0.25 to 2.5 percent by weight and cellulose gum being 0.25 to 2 percent by weight.

An oral care composition comprising 28 percent by weight glycerine; 13 percent by weight calcium peroxide; 6 percent by weight triethanolamine; 3 percent by weight EDTA acid; 3 percent by weight dequest 2010; 1.5 percent by weight sodium saccharinate; 13 percent by weight citric acid; and 2 percent by weight carbopol 934. There may also be a flavor composition being 1.5 percent by weight.

An oral care composition comprising: 26 percent by weight glycerine; 11 percent by weight calcium peroxide; 4 percent by weight triethanolamine; 2 percent by weight EDTA acid; 2 percent by weight dequest 2010; 1 percent by weight sodium saccharinate; 12 percent by weight citric acid; and 1.5 percent by weight carbopol 934. There may also be 2 percent by weight of a flavor composition, such as supersmile™. There may also be KOH being 0.25 to 2.5 percent by weight, cellulose gum being 0.25 to 2 percent by weight.

An oral care composition comprising: 25 percent by weight glycerine; 8 percent by weight calcium peroxide; 2 percent by weight triethanolamine; 1 percent by weight EDTA acid; 1 percent by weight dequest 2010; 0.5 percent by weight sodium saccharinate; 8 percent by weight citric acid; and 0.5 percent by weight carbopol 934. There may also be between 0.5 percent by weight of a flavor composition, such as supersmile™. In each of the composition there may also be 0.25 to 2.5 percent by weight KOH, and cellulose gum being 0.25 to 2 percent by weight.

It should be understood that the foregoing relates to preferred embodiments of the invention and that modifications may be made without departing from the spirit and scope of the invention as set forth in the following claims.

I claim:

1. An oral care composition comprising:
a tooth bleaching component;
a breath freshening component; and
an aqueous delivery matrix.

2. An oral care composition according to claim 1, wherein said tooth bleaching compound is comprised of calcium peroxide.

3. An oral care composition according to claim 1, wherein said breath freshening component is a flavor composition.

4. An oral care composition according to claim 1, wherein said aqueous delivery matrix is comprised of:
deionized water;
glycerine;
triethanolamine;
EDTA acid;
Dequest 2010;
sodium saccharinate;
citric acid; and
carbopol 934.

5. An oral care composition as in claim 4, further comprising KoH.

6. An oral care composition as in claim 4, further comprising cellulose gum.

7. An oral care composition comprising a tooth bleaching component, a breath freshening component and an aqueous delivery matrix, wherein said tooth bleaching component is calcium peroxide, said breath freshening component is a flavor composition and said aqueous delivery matrix is comprised of deionized water, glycerine, triethanolamine, EDTA acid, Dequest 2010, sodium saccharinate, citric acid and carbopol 934.

8. An oral care composition according to claim 7, wherein said calcium peroxide is between 6% and 17% by weight.

9. An oral care composition according to claim 7, wherein said a flavor composition is between 0.5% and 3% by weight.

10. An oral care composition according to claim 7, wherein said deionized water is between 13% and 53% by weight.

11. An oral care composition according to claim 7, wherein said glycerine is between 25% and 30% by weight.

12. An oral care composition according to claim 7,.wherein said triethenolamine is between 2% and 8% by weight.

13. An oral care composition according to claim 7, wherein said EDTA acid is between 1% and 4% by weight.

14. An oral care composition according to claim 7, wherein said Dequest 2010 is between 1% and 4% by weight.

15. An oral care composition according to claim 7, wherein said sodium saccherinate is between 0.5% and 2% by weight.

16. An oral care composition according to claim 7, wherein said citric acid is between 8% and 15% by weight.

17. An oral care composition according to claim 7, wherein the weight of said carbopol 934 is between 0.5% and 3% by weight.

18. An oral care composition according to claim 7, further comprising KOH and said KOH is between 0.5% and 2% by weight.

19. An oral care composition according to claim 7, further comprising cellulose gum and said cellulose gum is between 0.5% and 2% by weight.

20. An oral care composition, said oral care composition comprising:
24-33 percent by weight glycerine;
7-16 percent by weight calcium peroxide;
1-9 percent by weight triethanolamine;
1-5 percent by weight EDTA acid;
1-5 percent by weight dequest 2010;
0.25-2.5 percent by weight sodium saccharinate;
7-16 percent by weight citric acid; and
0.25-3.5 percent by weight carbopol 934.

21. An oral composition as in claim 20, further comprising between 0.25 to 2.5 percent by weight a flavor composition.

22. An oral care composition as in claim 20, further comprising KOH, said KOH being 0.25 to 2.5 percent by weight KOH;

23. An oral care composition as in claim 20, further comprising cellulose gum, said cellulose gum being 0.25 to 2 percent by weight.

24. An oral care composition as in claim 20, wherein said glycerine is 30 percent by weight, said calcium peroxide is 15 percent by weight, said triethanolamine is 8 percent by weight, said EDTA acid is 4 percent by weight, said dequest 2010 is 4 percent by weight, said sodium saccharinate is 2 percent by weight, said citric acid is 15 percent by weight, said carbopol 934 is 3 percent by weight and said a flavor composition is 2 percent by weight.

25. An oral care composition as in claim 20, wherein said glycerine is 28 percent by weight, said calcium peroxide is 13 percent by weight, said triethanolamine is 6 percent by weight, said EDTA acid is 3 percent by weight, said dequest 2010 is 3 percent by weight, said sodium saccharinate is 1.5 percent by weight, said citric acid is 13 percent by weight, said carbopol 934 is 2 percent by weight, said a flavor composition is 1.5 percent by weight.

26. An oral care composition as in claim 20, wherein said glycerine is 26 percent by weight, said calcium peroxide is 11 percent by weight, said triethanolamine is 4 percent by weight, said EDTA acid is 2 percent by weight, said dequest 2010 is 2 percent by weight, said sodium saccharinate is 1 percent by weight, said citric acid is 12 percent by weight, said carbopol 934 is 1.5 percent by weight and said a flavor composition is 1 percent by weight.

27. An oral care composition as in claim 20, wherein said glycerine is 25 percent by weight, said calcium peroxide is 8 percent by weight, said triethanolamine is 2 percent by weight, said EDTA acid is 1 percent by weight, said dequest 2010 is 1 percent by weight, said sodium saccharinate is 0.5 percent by weight, said citric acid is 8 percent by weight, said carbopol 934 is 0.5 percent by weight and said a flavor composition is 0.5 percent by weight.
